(19) United States
(12) Patent Application Publication
(10) Pub. No.: US 2012/0280065 A1
(43) Pub. Date: Nov. 8, 2012

(54) MULTI-CHAMBER TRIGGER SPRAYER

(76) Inventors: Donald D. Foster, St. Charles, MO (US); Philip L. Nelson, Wildwood, MO (US); Stephen R. Dennis, Danville, CA (US)

(21) Appl. No.: 13/553,689

(22) Filed: Jul. 19, 2012

Related U.S. Application Data
(63) Continuation-in-part of application No. 13/070,622, filed on Mar. 24, 2011.

(51) Int. Cl. B05B 1/14

(52) U.S. Cl. 239/375

(57) ABSTRACT

Described are multi-chamber trigger sprayers and fluid dispensing apparatuses, including a sprayer housing including a pump piston and at least two pump chambers, a closure attachment configured to couple the trigger sprayer to an opening of a container, at least two fluid discharge passageways, each passageway in fluid communication with one of the pump chambers, and at least two priming valves, each configured to prevent backflow of fluid into one of the at least two fluid discharge pathways, and a biasing element configured to bias the pump piston. In some embodiments, the biasing element may be disposed outside of the closure attachment and adjacent to a pivot point of the trigger. Some embodiments of the multi-chamber trigger sprayer may be formed entirely from plastic. Other embodiments may also be disclosed and claimed.

### CROSS REFERENCE TO RELATED APPLICATIONS

The present application is a Continuation-in-Part of and claims priority to U.S. patent application. Ser. No. 13/070,622, filed Mar. 24, 2011, entitled “MULTI-CHAMBER TRIGGER SPRAYER,” the disclosure of which is hereby incorporated by reference in its entirety.

### BACKGROUND

1. Field

Embodiments of the present disclosure relate to multi-chamber trigger sprayers configured to combine and discharge two or more fluids, and to apparatuses including a multi-chamber trigger sprayer.

2. Description of the Related Art

Trigger sprayers are those types of sprayers that can be held in a single hand of the user and operated by the fingers of the user's hand to pump fluid from a container connected to the trigger sprayer. A trigger sprayer typically includes a sprayer housing that contains a pump chamber and piston, and a sprayer fluid supply passageway that fluidly communicates a fluid inlet opening (sometimes also referred to as a “connector aperture”) with the pump chamber.

A dip tube is often sealingly coupled to the connector aperture, and extends through a neck of a container and into fluid contents of the container. The dip tube fluidly communicates the container with the fluid supply passageway of the sprayer housing.

Although the conventional trigger sprayer and container may be suitable for various applications, there may be situations in which it is undesirable to package a fluid product in a container due to instability or hazardousness of the fluid product. In these situations, mixing at the point of use of precursor fluids may be a suitable alternative.

### SUMMARY OF THE INVENTION

The present disclosure provides a multi-chamber trigger sprayer. In various embodiments, the trigger sprayer may be configured to couple to a container, and may include at least two fluid discharge passageways. Embodiments of the trigger sprayer may include a sprayer housing including at least one pump piston and at least two pump chambers, a closure attachment configured to couple the trigger sprayer to an opening of a container. At least two fluid discharge passageways, each fluid discharge passageway in fluid communication with one of the at least two pump chambers, and at least two priming valves, wherein each of the at least two priming valves is configured to prevent backflow of fluid into one of the at least two fluid discharge pathways. In various embodiments, axes of each of the at least two pump chambers, and at least portions of each of the at least two fluid discharge passageways, are configured to be parallel to the axis of the opening of the container.

In various embodiments, the trigger sprayer may include a trigger mounted on a sprayer housing for pivoting movement, the trigger being configured to actuate the pump piston to cause one or more fluids to be drawn from the container to corresponding ones of the pump chambers, and dispense the fluids from corresponding ones of the pump chambers to corresponding ones of the fluid discharge passageways.

In various embodiments, the trigger sprayer may include a nozzle assembly configured to combine the fluids from the fluid discharge passageways and discharge the combined fluid from the trigger sprayer upon actuation of the pump piston.

Various embodiments of the present disclosure also provide a fluid dispensing apparatus comprising a multi-chamber fluid dispensing container and a multi-chamber trigger sprayer coupled to the multi-chamber fluid dispensing container. In various embodiments, the container may include a body having at least one wall defining a first interior cavity and a second interior cavity, and a neck coupled to the body and including an opening providing access to the first interior cavity and to the second interior cavity. Embodiments of the multi-chamber trigger sprayer may include a first fluid discharge passageway fluidly connected to the first interior cavity, a second fluid discharge passageway fluidly connected to the second interior cavity, a first pump chamber connected to the first fluid discharge passageway, a second pump chamber connected to the second fluid discharge passageway, a first priming valve configured to prevent backflow of fluid into the first fluid discharge pathway, a second priming valve configured to prevent backflow of fluid into the second fluid discharge pathway, and a biasing element configured to bias a pump piston of the multi-chamber trigger sprayer to an upward position. In various embodiments, an axis of the first and second pump chambers is configured to be parallel to an axis of the opening of the container.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 shows a partially-sectioned side elevation view of a multi-chamber trigger sprayer, in accordance with a first embodiment of the present disclosure;

FIG. 2A shows a partially-sectioned plan view of the multi-chamber trigger sprayer of FIG. 1 taken along line 2A-2A;

FIG. 2B shows a partially-sectioned plan view of the multi-chamber trigger sprayer of FIG. 1 taken along line 2B-2B;

FIG. 3 shows a partially-sectioned side elevation view of the multi-chamber trigger sprayer of FIG. 1, with the trigger partially depressed;

FIG. 4 shows a partially-sectioned side elevation view of a multi-chamber trigger sprayer, in accordance with a second embodiment of the present disclosure;

FIG. 5 shows a side elevation view of an apparatus including the multi-chamber trigger sprayer of FIG. 1 and a multi-chamber fluid dispensing container, in accordance with various embodiments of the present disclosure;

FIG. 6 shows a perspective view of an apparatus including a multi-chamber trigger sprayer and a multi-chamber fluid dispensing container, with the trigger sprayer removed from the fluid dispensing container, both in accordance with a third embodiment of the present disclosure;

FIG. 7 shows a perspective view of an apparatus including a multi-chamber trigger sprayer and a multi-chamber fluid dispensing container, with the trigger sprayer removed from the fluid dispensing container, both in accordance with a fourth embodiment of the present disclosure;

FIG. 8 shows a side elevation view of a multi-chamber trigger sprayer, in accordance with a fifth embodiment of the present disclosure;

FIG. 9 shows a partially-sectioned side elevation view of the multi-chamber trigger sprayer of FIG. 8;

FIG. 10 shows a partially-sectioned rear elevation view of the multi-chamber trigger sprayer of FIG. 8;

FIG. 11 shows a partially sectioned perspective view of a nozzle assembly portion of the multi-chamber trigger sprayer of FIG. 8; and

FIG. 12 shows a partially sectioned side elevation view of a closure attachment portion of the multi-chamber trigger sprayer coupled to a multi-chamber fluid dispensing container, in accordance with various embodiments.

### DETAILED DESCRIPTION OF EMBODIMENTS

Reference will now be made to the drawings wherein like numerals refer to like parts throughout. For ease of description, the components of embodiments of the present disclosure are described in the normal (upright) operating position, and terms such as upper, lower, horizontal, etc., are used with reference to this position. It will be understood, however, that the components of embodiments of the present disclosure may be manufactured, stored, transported, used, and sold in an orientation other than the position described.

Figures illustrating the components of embodiments of the present disclosure show some conventional mechanical elements that may be known and that may be recognized by one skilled in the art. The detailed descriptions of such elements that are not necessary to an understanding of the disclosure, and accordingly are herein presented only to the degree necessary to facilitate an understanding of the novel features of the present disclosure.

As used herein and in the appended claims, the term “comprising” is inclusive or open-ended and does not exclude additional unrecited elements, compositional components, or method steps. Accordingly, the term “comprising” encompasses the more restrictive terms “consisting essentially of” and “consisting of.”

It must be noted that, as used in this specification and the appended claims, the singular forms “a,” “an,” and “the” include plural references unless the content clearly dictates otherwise. Similarly, the use of substantially any plural terms herein may be translated by those having skill in the art from the plural to the singular as is appropriate to the context and/or application. The various singular/plural permutations may be expressly set forth herein for sake of clarity.

In those instances where a convention analogous to “at least one of A, B, and C, etc.” is used, in general such a construction is intended in the sense one having skill in the art would understand the convention (e.g., “an apparatus having at least one of A, B, and C” would include but not be limited to apparatuses that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 elements refers to groups having 1, 2, or 3 elements. Similarly, a group having 1-5 elements refers to groups having 1, 2, 3, 4, or 5 elements, and so forth.

Unless defined otherwise, all technical and scientific terms used herein have the same meaning as commonly understood by one of ordinary skill in the art to which embodiments of the present disclosure pertain. Although a number of methods and materials similar or equivalent to those described herein can be used in the practice of the present disclosure, the preferred materials and methods are described herein.

The term “container” or “bottle,” as used herein, is meant to mean and include any container for holding a fluid material. A container or bottle may be made of any suitable material, depending upon the product therein. For example, a container or bottle may be made of plastic, metal, or glass.

Broadly, embodiments of the present disclosure provide multi-chamber trigger sprayers configured to combine and discharge two or more fluids, and to apparatuses including a multi-chamber trigger sprayer. In various embodiments, the multi-chamber trigger sprayer may include a sprayer housing including a pump piston and at least two pump chambers, a closure attachment configured to couple the trigger sprayer to an opening of a container, and at least two fluid discharge passageways, each passageway in fluid communication with one of the pump chambers. In some embodiments, a biasing element may be configured to bias a pump piston of the multi-chamber trigger sprayer, wherein axes of each of the at least two pump chambers, at least portions of each of the at least two fluid discharge passageways, and the biasing element, are configured to be parallel to the axis of the opening of the container. In other embodiments, axes of each of the at least two pump chambers and at least portions of each of the at least two fluid discharge passageways are configured to be parallel to the axis of the opening of the container, but the biasing element may span a rear pivot on the trigger mechanism. In some embodiments, the biasing element may be a metal element, such as a coiled spring, whereas in other embodiments the biasing element may be a leaf spring, for instance a leaf spring formed from plastic.

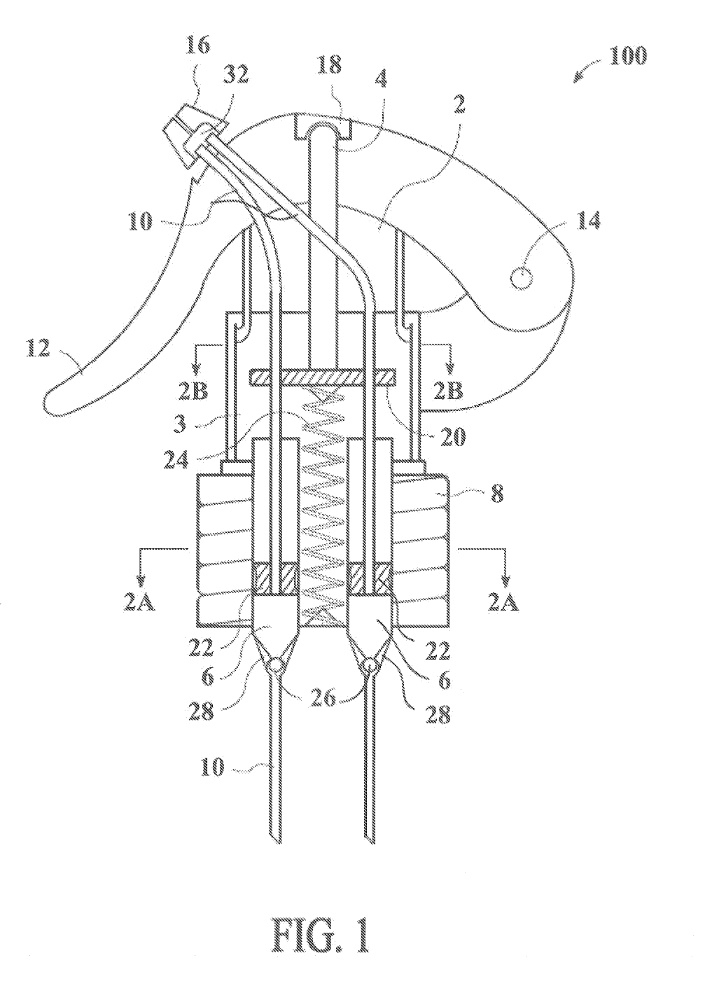

FIG. 1 is a partially-sectioned side elevation view of a multi-chamber trigger sprayer 100, in accordance with various embodiments of the present disclosure. As illustrated, in some embodiments, the trigger sprayer 100 may include a sprayer housing 2 including a pump piston 4, at least two pump chambers 6, and a closure attachment 8 configured to couple the trigger sprayer 100 to an opening of a container. In various embodiments, the trigger sprayer 100 may also include at least two fluid discharge passageways 10. Each passageway 10 may be in fluid communication with one of the pump chambers 6 as shown, wherein axes of each of the at least two pump chambers 6 and at least portions of each of the at least two fluid discharge passageways 10 may be configured to be parallel to the axis of the opening of the container, as shown more clearly herein.

In various embodiments, the trigger sprayer 100 may include a trigger 12 mounted on the sprayer housing 2, 3 for pivoting movement about a pivot point 14, and a nozzle assembly 16 for dispensing a fluid from the trigger sprayer 100. The sprayer housing 2, 3 may be configured in any manner suitable for practicing the described embodiments. For example, the sprayer housing 2, 3 may have a telescoping configuration as shown in which a first portion 2 moves along with the trigger 12, upon depression and release, sliding into (or outside of, not shown) the fixed second portion 3 of the housing.

The trigger 12 may be configured to actuate the pump piston 4 to cause fluids to be drawn from a container, to which the trigger 12 may be attached, to the at least two pump chambers 6 and then dispensed from the at least two pump chambers 6 to the at least two fluid discharge passageways 10. As shown, the pump piston 4 includes a first piston element 20 skirting each of the fluid discharge passageways 10, and second piston elements 22 located in each of the pump chambers 6. The first piston element 20 may skirt or otherwise be coupled to each of the fluid discharge passageways 10, may also be in contact with a biasing element 24 as illustrated. One or more of the fluid discharge passageways 10 may comprise a flexible tubing material or any other tubing suitable for practicing the described embodiments.

Rather than being located within the pump chambers 6, in various embodiments, the biasing element 24 may be located externally to the pump chambers 6, as shown. In this configuration, fewer parts may be required for assembling the trigger sprayer 2. The biasing element 24 may be a metal or plastic spring, or any other suitable apparatus or material for biasing upward toward the first piston element 20.

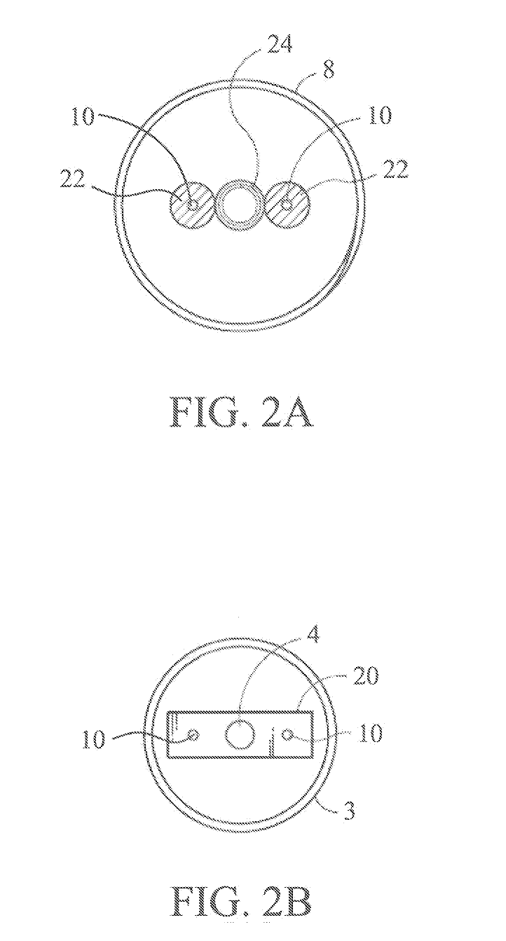

To facilitate understanding of the structure of the trigger sprayer 100, various plan views are shown in FIG. 2A-2B. FIG. 2A is a partially-sectioned plan view of the trigger sprayer 100 taken generally along line 2A-2A of FIG. 1, showing the closure attachment 8, the biasing element 24, the fluid discharge passageways 10, and the second piston elements 22. FIG. 2B is a partially-sectioned plan view of the trigger sprayer 100 taken generally along line 213-2B of FIG. 1, showing the piston 4 including the first piston element 20, the fluid discharge passageways 10, and the sprayer housing 3.

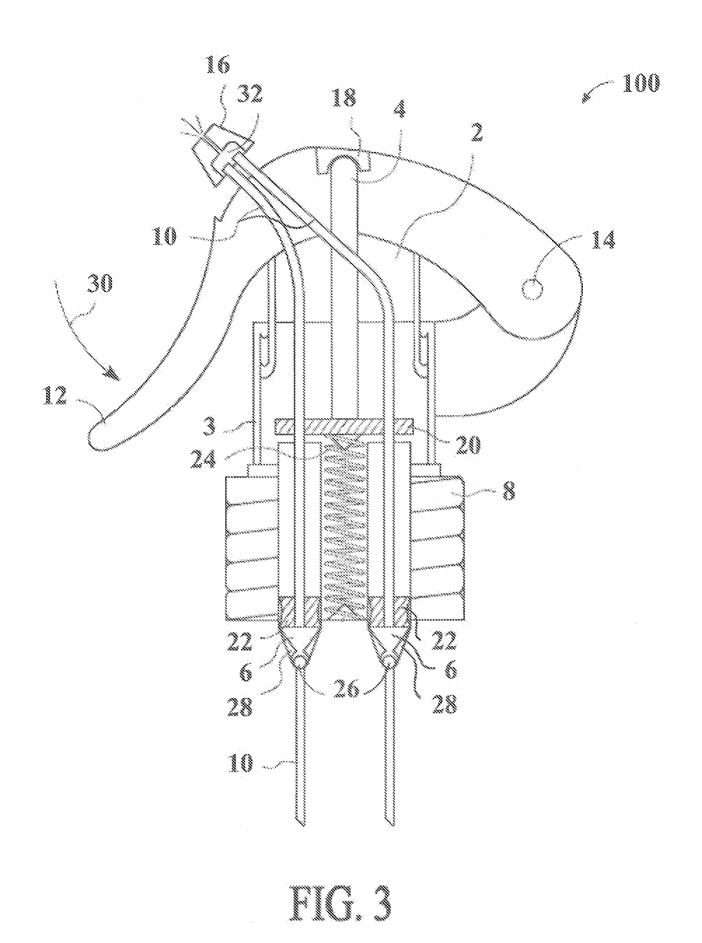

Operation of the trigger sprayer 100 may be understood with reference to FIG. 3 with continued reference to FIG. 1. A shown, the sprayer housing 2 may include a notch 18 or similar feature for pressing down against the pump piston 4 with appurtenant compression of the pump chambers 6 by the pump elements 22 during operation of the trigger sprayer 100 (i.e., when the trigger 12 is depressed). When the trigger is depressed along direction 30, the pump piston sections 22 are forced downwards, compressing the bottom portions of the pump chambers 6, as illustrated in FIG. 3.

Attached to the pump chambers 6 are one-way valves, each including a valve ball 26 and a keeper 28 for limiting up and down movement of the valve balls 26. As with typical one-way valves, fluid flow is limited to one direction, and prevented in the opposite direction. Accordingly, in operation of the trigger sprayer 100, on the downstroke, the valve balls 26 block flow of fluid back down into the bottom portion of the fluid passageways 10, thereby causing increased pressure within the pump chambers 6. The increased pressure causes fluid to flow from the pump chambers 6 up through the fluid discharge passageways 10, and to the nozzle assembly 16 for discharge from the trigger sprayer 100.

Prior to discharge from the nozzle assembly 16, the fluids from each of the fluid discharge passageways 10 may be combined in a mixing chamber 32. Accordingly, the configuration of the trigger sprayer 100 may allow for separate types of fluids to be mixed just at the point-of-use. For example, it may be undesirable in some situations to package a fluid product in a container due to instability or hazardousness of the fluid product. In these or other situations, mixing at the point of use of precursor fluids may be a suitable alternative.

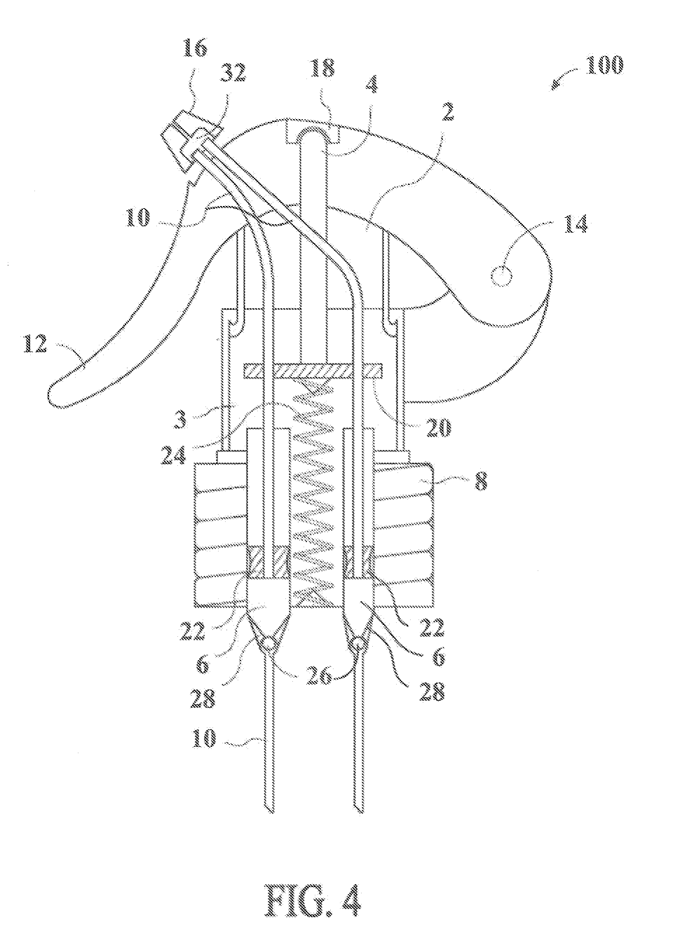

The ratio of precursor fluids combined at the mixing chamber 32 oldie nozzle assembly 16 may be one-to-one or other than one-to-one. In various embodiments for other than one-to-one mixing, the trigger sprayer 100 may be configured to combine a first volume of a first precursor fluid from a first interior cavity of a container with a second volume of a second precursor fluid from a second interior cavity of the container, wherein the first volume is different from the second volume. FIG. 4 shows a partially-sectioned side elevation view of a multi-chamber trigger sprayer, in accordance with a second embodiment of the present disclosure, in which the piston chambers 6 are two different sizes, and accordingly, configured to hold two different volumes of fluid. Thus, when the trigger 12 is depressed, the pump piston sections 22 are forced downwards, compressing the bottom portions of the pump chambers 6, forcing two different volumes of fluid from the pump chambers 6 up through the fluid discharge passageways 10. The differing volumes of fluids may then be combined in the mixing chamber 32, and then discharged by the nozzle assembly 16.

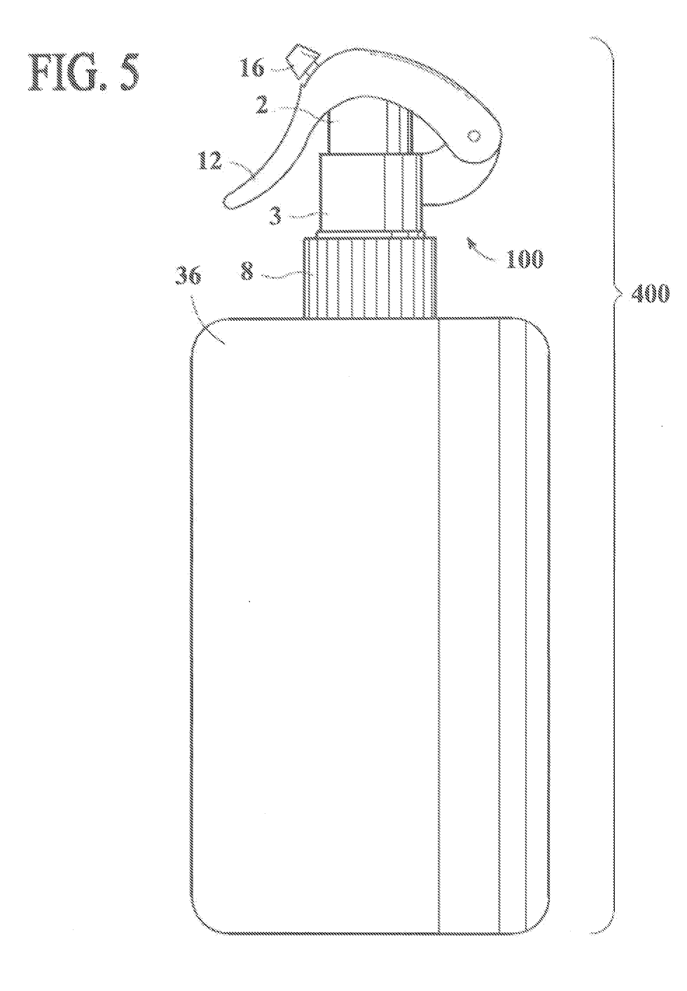

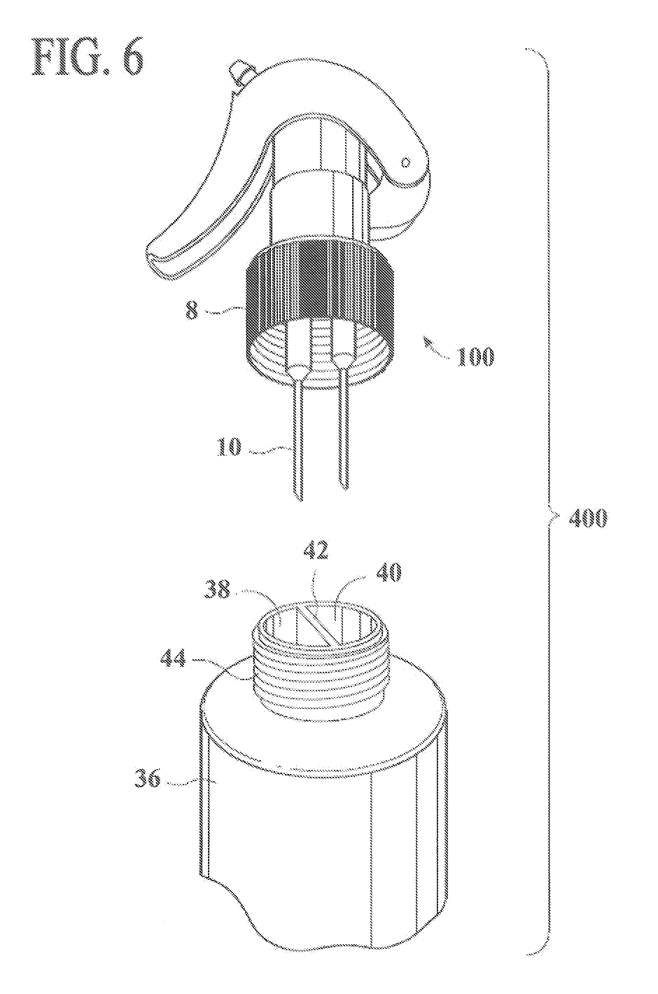

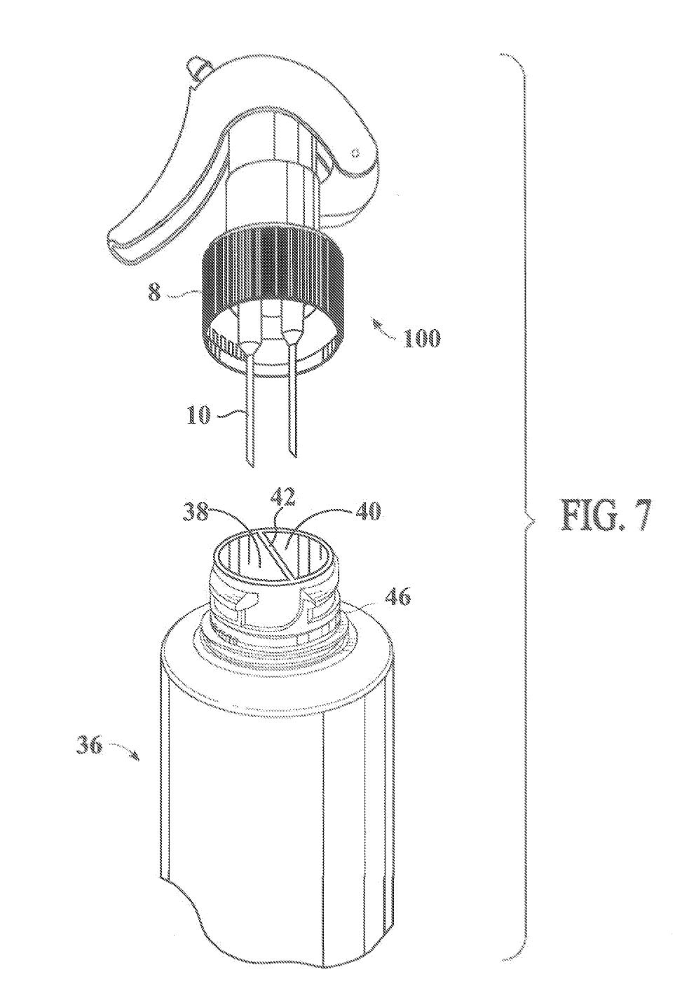

FIG. 5 shows an example fluid dispensing apparatus 400 including a multi-chamber trigger sprayer 100 and a multi-chamber fluid dispensing container 36, both in accordance with various embodiments of the present disclosure. FIG. 6 shows a perspective view of the fluid dispensing apparatus 400. The closure attachment 8 of the trigger sprayer 100 may be coupled to the container 36 as shown. To facilitate attachment, the closure attachment 8 may be configured to correspond to the fitment 44 of the trigger sprayer 100. As illustrated, the container 36 may include a threaded fitment 44, and the trigger sprayer 100 may be complementary configured with a threaded closure attachment 8. Alternatively, the container 36 may include a bayonet-type fitment 46, and the trigger sprayer 100 may be complementary configured with a bayonet-type closure attachment 8, as shown in FIG. 7.

As shown in FIG. 6 and FIG. 7, the container 36 may include a first interior cavity 38 and a second interior cavity 40, corresponding to first and second fluid discharge passageways described herein. The first interior cavity 38 and the second interior cavity 40 may be separated from each other by a divider wall 42 to ensure no mixing of fluids between the cavities 38, 40 prior to discharge from the trigger sprayer 100. When the trigger sprayer 100 and container 36 are coupled, the fluid discharge passageways 10 may be fluidly connected to respective interior cavities 38, 40.

As described herein, prior to discharge from the nozzle assembly 16, the fluids from each of the fluid discharge passageways 10 may be combined in a mixing chamber 32 of the nozzle assembly 16 to allow fluids to be mixed at the point-of-use. The separate interior cavities 38, 40 may thus hold the separate precursor fluids for combining at the mixing chamber 32.

For embodiments in which the ratio of precursor fluids combined at the mixing chamber 32 of the nozzle assembly 16 is one-to-one, the cavities 38, 40 of the container 36 may have substantially the same fluid capacities. For embodiments in which the ratio of precursor fluids combined at the mixing chamber 32 of the nozzle assembly 16 is other than one-to-one, however, it would be expected that more of one of the precursor fluids would be needed than the other one of the precursor fluids. Accordingly, the interior cavities 38, 40 may be configured with differing fluid capacities to allow one of the cavities 38, 40 to hold more than the other one of the cavities 38, 40.

Among the various benefits of the described embodiments, providing pump chambers and at least portions of each of the fluid discharge passageways having axes parallel to the axis of the opening of the container may simplify the manufacturing process for making the trigger sprayer relative to various other related art trigger sprayers. For example, the piston 4, 22 and pump chamber 6 may be produced in one part and coupled to the closure attachment 8. The fluid discharge passageways 10 may be of a flexible material to allow the vertical orientation to transfer to a substantially horizontal orientation and to a fixed location. Disposing the biasing element 24 externally of the pump chambers 6 allows for a single biasing element to bias the multiple pump pistons 4, 22, thereby reducing the number of parts required to manufacture the trigger sprayer. Disposing the biasing element 24 externally of the pump chambers 6 may also reduce exposure of the biasing element 24 to the fluids, possible extending the lifetime of the trigger sprayer.

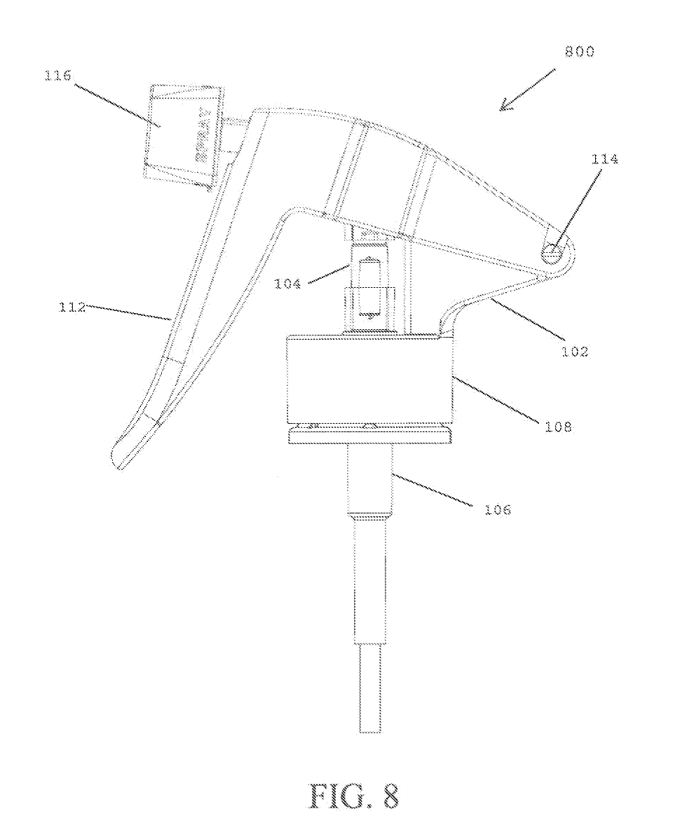

FIG. 8 shows a side elevation view of another example of a multi-chamber trigger sprayer, in accordance with a fifth embodiment of the present disclosure. As illustrated, like the other embodiments disclosed herein, the trigger sprayer 800 may include a sprayer housing 102 including at least one pump piston 104, at least two pump chambers 106, and a closure attachment 108 configured to couple the trigger sprayer 800 to an opening of a container. In various embodiments, the trigger sprayer 800 also may include a trigger 112 coupled to the sprayer housing 102 at a pivot point 114, and a nozzle assembly 116 for dispensing a fluid from the trigger sprayer 800.

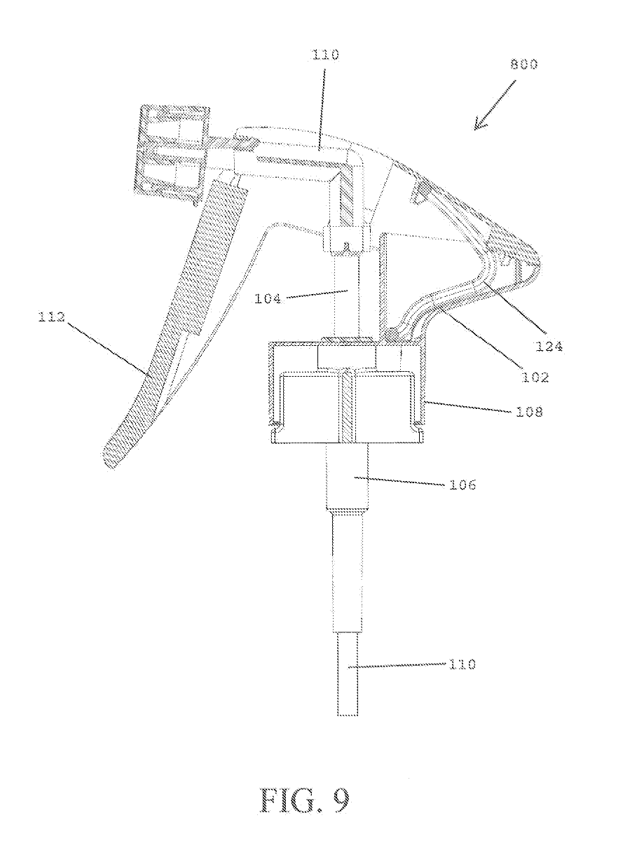

As is better illustrated in FIG. 9, which shows a partially-sectioned side elevation view of the multi-chamber trigger sprayer of FIG. 8, in various embodiments, the trigger sprayer 800 may also include at least two fluid discharge passageways 110. Each fluid discharge passageway 110 may be in fluid communication with one of the pump chambers 106, and axes of each of the at least two pump chambers 106 and at least portions of each of the at least two fluid discharge passageways 110 may be configured to be parallel to the axis of the opening of the container, as described above with respect to the foregoing examples.

In various embodiments, the trigger 112 may be configured to actuate the pump piston 104 to cause fluids to be drawn from a container to the at least two pump chambers 106 and then dispensed from the at least two pump chambers 106 to the at least two fluid discharge passageways 110. Rather than being located within or adjacent to the pump chambers 106 or within the closure attachment 108, in various embodiments, a biasing element 124 may be located external to the pump chambers 106 and closure attachment 108, as shown. In some embodiments, the biasing element 124 may be disposed adjacent to a pivot point 114 (shown in FIG. 8) of the trigger 112. In some embodiments, the biasing element may span at least a portion of both the trigger 112 and a portion of the sprayer housing 102 about a pivot point 114. In this configuration, fewer parts and or fewer steps may be required for assembling the trigger sprayer 800 as compared to known dual chamber trigger sprayers, and such a placement of the biasing element 124 may result in a more efficient biasing of the trigger 112 relative to the sprayer housing 102. The biasing element 124 may be a plastic spring in some embodiments, such as a plastic leaf spring. In particular embodiments, all of the trigger sprayer mechanism and the container it couples to may be made of plastic in its entirety, which may simplify and facilitate recycling of the trigger sprayer.

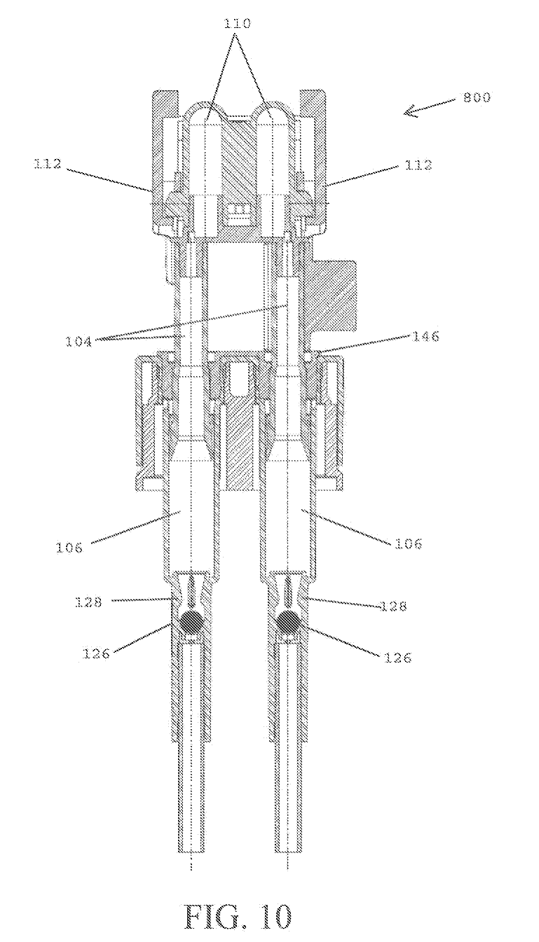

FIG. 10 shows a partially-sectioned rear elevation view of the multi-chamber trigger sprayer of FIG. 8. As shown in FIG. 10, the pump piston 104 may couple to the fluid discharge pathway 110, and may pass through a snap ring 146 that skirts each of the pump pistons 104 and secures them to the sprayer housing. In various embodiments, the pistons 104 may then fit inside and telescope into the pump chambers 106. In various embodiments, all or part of the fluid discharge passageways 110 may comprise molded plastic tubing, which facilitates assembly of the trigger sprayer 800.

Operation of the trigger sprayer 800 may be understood with reference to FIG. 10 with continued reference to FIGS. 8 and 9. As shown, the trigger 112 may press directly or indirectly onto the pistons 104, forcing them downwards during operation of the trigger sprayer 800 (e.g., when the trigger 112 is depressed). This downward force on the pistons 104 will cause them to telescope into and reduce the fluid volume inside of the pump chambers 106.

In various embodiments, attached to the pump chambers 106 are one-way valves, each including a valve ball 126 and a keeper 128 for limiting up and down movement of the valve hall 126. As with typical one-way valves, fluid flow is limited to one direction, and prevented in the opposite direction. Accordingly, in operation of the trigger sprayer 800, on the downstroke, the valve halls 126 block flow of fluid hack down into the bottom portion of the fluid discharge passageways 110 (e.g., the dip tubes), thereby causing increased pressure within the pump chambers 106. The increased pressure causes fluid to flow from the pump chambers 106 up through the fluid discharge passageways 110, and to the nozzle assembly 116 for discharge from the trigger sprayer 800. Conversely, on the trigger upstroke, the ball valves open and allow fluid to enter the bottom portion of each fluid discharge passageway from its corresponding container compartment.

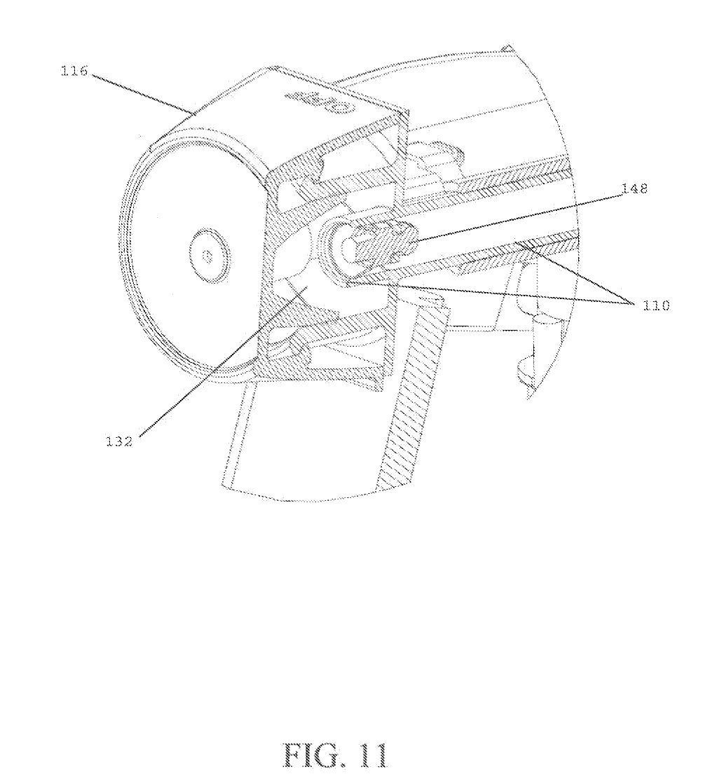

FIG. 11 shows a partially sectioned perspective view of a nozzle assembly portion of the multi-chamber trigger sprayer of FIG. 8. As illustrated in FIG. 11, prior to discharge from the nozzle assembly 116, the fluids from each of the fluid discharge passageways 110 may be combined in a mixing chamber 132. Accordingly, the configuration of the trigger sprayer may allow for separate types of fluids to be mixed just at the point-of-use. For example, as described above with respect to the foregoing embodiments, it may be undesirable in some situations to package a fluid product in a container due to instability or hazardousness of the fluid product. In these or other situations, mixing at the point of use of precursor fluids may be a suitable alternative. As described above with respect to other embodiments, the ratio of precursor fluids combined at the mixing chamber 132 of the nozzle assembly 116 may be one-to-one or other than one-to-one, and such ratios may be adjusted by varying the volumes of the pump chambers with respect to one another.

Housed within or adjacent to the mixing chamber 132, for instance at the distal tips of the fluid discharge passageways 110, are one-way priming valves 148, each configured to limit fluid flow to one direction and prevent backflow of fluid into the fluid discharge pathways once it has entered the mixing chamber 132. Accordingly, during operation of the trigger sprayer, on the downstroke, the priming valves 148 allow fluid to pass out of each fluid discharge passageway 110 and into the mixing chamber 132, and on the return stroke, the priming valves close off the fluid discharge passageways 110 to block flow of fluid back clown into the distal ends of the fluid discharge pathways 110 from the mixing chamber 132. In some embodiments, this may be advantageous, since backflow of the mixed fluid into the fluid discharge passageways 110 may lead to cross-contamination of the two fluid passageways 100, and even to cross-contamination of the two separate fluid reservoirs in the container. Because the two (or more) fluids may be dangerous or unstable once combined, this could result in fouling of the fluids, and/or the creation of a hazardous mixture within the trigger sprayer or container. Thus, the two (or more) priming valves maintain the integrity of each separate fluid path.

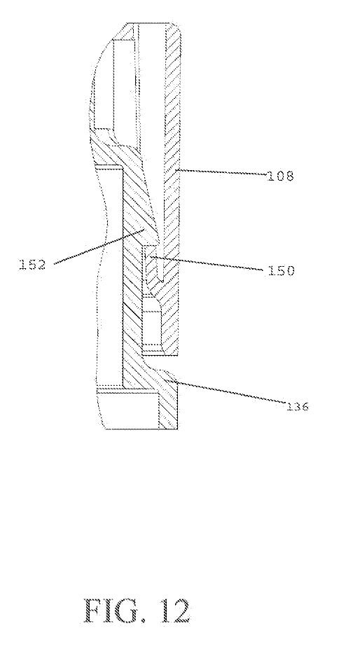

FIG. 12 shows a partially sectioned side elevation view of a closure attachment portion of the multi-chamber trigger sprayer coupled to a multi-chamber fluid dispensing container, in accordance with various embodiments. In various embodiments, the closure attachment 10 the trigger sprayer may be coupled to the container 136 as shown. To facilitate attachment, the closure attachment 108 may include a lip 150 configured to couple to a corresponding feature 152 on the neck of the container 136, for example to prevent uncoupling of the trigger sprayer from the container 136 once the two components have been coupled together. One of skill in the art will appreciate that other types of closure fitments may be substituted, such as a barbed, bayonet, or threaded coupling.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the appended claims.

What is claimed is:

1. A trigger sprayer comprising:
a sprayer housing including at least one pump piston and at least two pump chambers;
a closure attachment configured to couple the trigger sprayer to an opening of a container;
at least two fluid discharge passageways, each fluid discharge passageway in fluid communication with one of the at least two pump chambers; and
at least two priming valves, wherein each of the at least two priming valves is configured to prevent backflow of fluid into one of the at least two fluid discharge passageways, and wherein axes of each of the at least two pump chambers and at least a portion of each of the at least two fluid discharge passageways, are configured to be parallel to an axis of the opening of the container.

2. The trigger sprayer of claim 1, wherein each of the at least two priming valves is disposed within a corresponding one of the at least two fluid discharge passageways.

3. The trigger sprayer of claim 1, further comprising a trigger mounted on the sprayer housing for pivoting movement, the trigger being configured to actuate the at least one pump piston to cause fluids to be drawn from separate chambers of the container to the at least two pump chambers, and to dispense the fluid from the at least two pump chambers to the at least two fluid discharge passageways.

4. The trigger sprayer of claim 1, further comprising a nozzle assembly configured to combine fluids from the at least two fluid discharge passageways, and to discharge the combined fluid from the trigger sprayer upon actuation of the at least one pump piston.

5. The trigger sprayer of claim 3, further comprising a biasing element configured to bias the pump piston to an upward position, wherein the biasing element is disposed externally of the closure attachment.

6. The trigger sprayer of claim 5, wherein the biasing element spans a pivot point of the trigger.

7. The trigger sprayer of claim 6, wherein the biasing element comprises a leaf spring.

8. The trigger sprayer of claim 6, wherein the biasing element is plastic.

9. The trigger sprayer of claim 1, wherein the trigger sprayer is formed entirely from plastic.

10. The trigger sprayer of claim 1, wherein the at least two fluid discharge passageways comprise molded plastic tubes.

11. A fluid dispensing apparatus comprising:
a multi-chamber fluid dispensing container including:
a body having at least one wall defining a first interior cavity and a second interior cavity;
a neck coupled to the body and including an opening providing access to the first interior cavity and to the second interior cavity;
a multi-chamber trigger sprayer having a sprayer housing coupled to the neck of the multi-chamber fluid dispensing container, and comprising:
a first fluid discharge passageway fluidly connected to the first interior cavity;
a second fluid discharge passageway fluidly connected to the second interior cavity;
a first pump chamber connected to the first fluid discharge passageway;
a second pump chamber connected to the second fluid discharge passageway;
a first priming valve configured to prevent backflow of fluid into the first fluid discharge pathway;
a second priming valve configured to prevent backflow of fluid into the second fluid discharge pathway; and
a biasing element configured to bias a pump piston of the multi-chamber trigger sprayer to an upward position;
wherein an axis of the first and second pump chambers is configured to be parallel to an axis of the opening of the container.

12. The fluid dispensing apparatus of claim 11, further comprising a trigger mounted on the sprayer housing.

13. The fluid dispensing apparatus of claim 12, wherein the trigger is mounted on the sprayer housing for pivoting movement, the trigger being configured to actuate the pump piston to cause fluids to be drawn from the first and second interior cavities of the multi-chamber fluid dispensing container to the first and second fluid discharge passageways.

14. The fluid dispensing apparatus of claim 13, wherein the biasing element is disposed external to the neck of the multi-chamber fluid dispensing container.

15. The fluid dispensing apparatus of claim 14, wherein the biasing element is disposed adjacent a pivot point of the trigger.

16. The fluid dispensing apparatus of claim 11, wherein the biasing element comprises a leaf spring.

17. The fluid dispensing apparatus of claim 11, wherein the biasing element is plastic.

18. The fluid dispensing apparatus of claim 11, wherein the entire fluid dispensing apparatus is formed from plastic.

19. The fluid dispensing apparatus of claim 12, further comprising a nozzle assembly configured to combine fluids from the first and second fluid discharge passageways, and to discharge the combined fluid from the trigger sprayer upon actuation of the pump piston.

20. A fluid dispensing apparatus comprising:
a sprayer housing including a pump piston, a first pump chamber, and a second pump chamber;
a closure attachment configured to couple the sprayer housing to an opening of a multi-chamber fluid dispensing container; and
a first fluid discharge passageway and a second fluid discharge passageway, each fluid discharge passageway in fluid communication with one of the pump chambers;
a first priming valve and a second valve, each of the first and second priming valves configured to prevent backflow of fluid into the first and second fluid discharge pathways;
a trigger mounted on the sprayer housing for pivoting movement to cause one or more fluids to be drawn from the container to corresponding ones of the first and second pump chambers and dispense the fluids from corresponding ones of the first and second pump chambers to corresponding ones of the first and second fluid discharge passageways;
a biasing element configured to bias the pump piston to an upward position, wherein the biasing element is disposed external to the closure attachment and adjacent a pivot point of the trigger, wherein axes of the first and second pump chambers and at least portions of the first and second fluid discharge passageways are configured to be parallel to the axis of the opening of the multi-chamber fluid dispensing container; and
a nozzle assembly configured to combine the fluids from the first and second fluid discharge passageways and discharge the combined fluid from the trigger sprayer upon actuation of the pump piston.
